(19) United States
(12) Patent Application Publication
(10) Pub. No.: US 2012/0074150 A1
(43) Pub. Date: Mar. 29, 2012

(54) DEVICE FOR STORING HOT, CORROSIVELY ACTIVE LIQUIDS AND USE OF THE DEVICE

(75) Inventors: Jürgen Wortmann, Limburgerhof (DE); Michael Lutz, Speyer (DE); Fabian Seeler, Dossenheim (DE); Martin Gärtner, Worms (DE); Felix Major, Freinsheim (DE); Kerstin Schierle-Arndt, Zwingenberg (DE); Otto Machhammer, Mannheim (DE); Günther Huber, Ludwigshafen (DE); Stephan Maurer, Neustadt-Gimmeldingen (DE); Karolin Geyer, Mannheim (DE)

(73) Assignee: BASF SE, Ludwigshafen (DE)

(21) Appl. No.: 13/247,452

(22) Filed: Sep. 28, 2011

Related U.S. Application Data
(60) Provisional application No. 61/387,491, filed on Sep. 29, 2010.

(51) Int. Cl. A47J 41/00

(52) U.S. Cl. 220/592.2

(57) ABSTRACT

The invention relates to a device for receiving hot, corrosively acting liquids (7), comprising a space enclosed by a wall (21) for receiving the liquid (7), the space having an inner insulation (19). The invention also relates to the use of the device for storing corrosively acting liquids for storing a heat storage medium comprising sulfur.

The invention is based on a device for receiving hot, corrosively active liquids, comprising a space enclosed by a wall for receiving the liquid. Furthermore, the invention also relates to a use of the device.

The device for receiving hot, corrosively active liquids is, for example, a tank which is used for receiving the heat storage medium in a solar power plant. In a solar power plant, heat is generated during the day, as long as the sun shines, by means of the solar energy. The heat is used for generating electricity. Generally, the heat is used to vaporize water and to drive a generator for generating electricity by the steam produced.

To allow a solar power plant to be operated continuously, a heat storage medium is heated up by means of the solar energy. This heat storage medium is stored in a well insulated tank. To extract heat, for example when the sun is not shining, the heated heat storage medium is removed and used for example far vaporizing water. The heat storage medium thereby gives off heat and is cooled. The cold heat storage medium is then, for example, made to pass into a second tank, for cold heat storage medium. To make uninterrupted operation possible in a solar power plant, large solar power plants require very large heat reservoirs.

To vaporize the water in a solar power plant and heat the steam to a temperature appropriate for operation, it is necessary to heat the heat storage medium to correspondingly high temperatures. At present, a heat reservoir in a solar power plant is operated at a working temperature in the range between 290 and 390° C. Moreover, it is currently being attempted to extend the temperature range to 550° C., or even to temperatures above that.

Molten salts, for example, are used as heat storage media. On account of the large amount of heat storage medium that is required to operate a large solar power plant, here, too, alternatives are being sought. Alternative heat storage media are, for example, also those comprising sulfur. Both in the case of molten salts and in the case of sulfur-comprising heat storage media, at high temperatures corrosion occurs on the tanks, which are usually produced from steel. For example, some molten nitrates may cause the embrittlement of various high-grade steels at temperatures over 550° C. Although the high-grade steels remain stable, they become sensitive to impact. In the case of storage materials comprising large amounts of sulfur, for example sulfur comprising 1% by weight potassium sulfide, notable corrosion occurs at temperatures above 350° C., leading to rapid penetrative destruction of typical iron- and nickel-based high-grade steels as the temperature increases above 400° C. Chloride-comprising molten salts are also highly corrosive at high temperatures. At lower temperatures, the corrosivity is much less, in some cases even non-existent.

Materials which withstand corrosive substances even at high temperatures are, for example, ceramics and glasses. However, these materials generally cannot be joined together without seals to form large structures, such as are necessary for heat storage tanks. Sealing material that is used can be corrosively attacked at high temperatures. In addition, these materials are generally brittle and, when joined together to form a structure, cannot withstand high internal pressures.

It is therefore an object of the present invention to provide a device for receiving hot, corrosively acting liquids which is corrosion-resistant and sealed and has sufficient mechanical stability to be able to receive even large amounts of liquid.

The object is achieved by a device for receiving hot, corrosively acting liquids which comprises a space enclosed by a wall for receiving the liquid, the space having an inner insulation.

In this case either the inner insulation may lie directly against the wall of the tank or there may be a gap formed between the inner insulation and the wall.

The inner insulation avoids the hot liquid comprised in the space coming into contact with the wall. As a result of the insulating effect of the inner insulation, the temperature of the side facing the wall is much lower than the temperature of the hot liquid. This achieves the effect that the temperature of the wall bounding the space can be kept below the temperature at which corrosion occurs.

To protect the inner insulation from inadmissible forces acting on it, in particular when there is a gap between the inner insulation and the wall of the space in which the liquid is kept, the inner insulation preferably has passages through which the liquid can flow. As a result, a pressure equalization is established on the inside of the insulation and the outside of the insulation. The inner insulation consequently does not need to be stable with respect to a pressure acting from the inside. In particular if the gap between the inner insulation and the wall is not uniform, or else in some places the inner insulation lies against the wall and in some places a gap is produced, liquid flows through the passages into the gap until pressure equalization is established. This avoids deforming of the inner insulation, which could possibly lead to destruction.

The passages are in this case designed in such a way that liquid can flow into the passages but no convection occurs. This makes it possible for liquid to flow out of the tank through the passages, but no mass transfer to take place in the passages once they have been filled. In particular when the liquid to be filled has a low thermal conductivity, for example in the case of a molten sulfur, the liquid comprised in the passages then also has an insulating effect. Although the liquid comes into contact with the wall of the space as a result of passing through the passages, it has a lower temperature than the liquid in the reservoir, the thickness of the insulation being chosen such that the temperature in the region of the wall is so low that no corrosion occurs, or at least only minimal corrosion.

To compensate for a different thermal expansion of the material of the inner insulation and the wall by which the space is enclosed, it is preferred if the inner insulation has expansion joints. The expansion joints are preferably likewise dimensioned such that no convection occurs in them. In a preferred embodiment, the passages in the inner insulation for pressure equalization serve at the same time as expansion joints, which are used to prevent the inner insulation from being destroyed by thermal expansion. In this way it is possible to even withstand loads caused by exposure to changing temperatures without the inner insulation being destroyed.

The size of the passages and/or the expansion joints is dependent here on the viscosity of the liquid comprised in the space.

Even in the case of open-pored refractory insulating bricks, from which the inner insulation may be produced for example, although liquid penetrating into the pores reduces the insulating quality of the insulating bricks, the low thermal conductivity of the liquid, for example of sulfur, is sufficient to build up a sufficiently strong insulation.

The inner insulation may, for example, be built up from substantially cuboidal elements. Substantially cuboidal elements also comprise elements in which the width increases outwardly to match a tank with a circular cross section, so that the expansion joints between the elements have a uniform width, and elements which are designed in the form of circular segments which match the diameter of the tank. The passages or expansion joints are, for example, gaps between the cuboidal elements. Further prevention of convection is possible by the cuboidal elements being laid in rows in an offset manner to build up the inner insulation. A gap between two cuboidal elements is then only as high in each case as such a cuboidal element and is interrupted by a cuboidal element of the next row.

The inner insulation may be both self-supporting and formed by securing insulating elements to the wall. In the case of self-supporting insulation, insulating elements are, for example, laid in rows to form an inner wall, it being possible for this wall to be freestanding or lying against the wall of the space. This is particularly preferred if the self-supporting inner insulation has expansion joints.

To improve the insulation further, it is possible to form a second insulating layer between the wall and the inner insulation. The second insulating layer may in this case be formed from the same material as the inner insulation. It is also possible to use two different materials.

If a second insulating layer is included between the wall and the inner insulation, it is possible, for example, for the inner insulation, which is preferably self-supporting, to be formed from an abrasion-resistant material, for example refractory brick of alumina, and the second insulating layer to comprise a highly insulating material, for example glass foam.

The inner insulation may also be built up from more than two layers. In this case, at least one layer is preferably a self-supporting inner insulation, while the other layers may or may not be self-supporting. It is also possible, for example, to build up alternating self-supporting insulating layers and highly insulating material in multiple layers. Furthermore, however, it is also possible for all the layers of the insulation to be self-supporting.

In particular if the second insulating layer is not self-supporting, it is advantageous if it is bounded on the inside and on the outside by a self-supporting inner insulation. It is preferred, however, if each layer of the insulation is self-supporting.

In a preferred embodiment, a seal of a corrosion-stable material is included between the inner insulation and the wall. The seal of corrosion-stable material may be, for example, an inliner, for example in the form of a corrugated metal sheet. The use of a seal of a corrosion-stable material makes it possible to use a non-corrosion-stable metal for the wall. Corrosion-stable materials, for example corrosion-stable high-grade steels, are generally expensive and also have lower strength values than steels that are not corrosion-stable with respect to the liquid comprised in the space. Use of the seal of the corrosion-stable material makes it possible to produce the wall of the enclosed space, for example a tank, from a steel which is not stable with respect to the liquid comprised in the space. The seal of the corrosion-stable material helps to avoid the liquid that is comprised in the space coming into contact with the wall.

The device for storing the hot, corrosively active liquid is, for example, a tank. This generally has a wall and a cover, so as to produce a closed space in which the hot, corrosively active liquid is comprised. The wall of the tank may be made, for example, from materials typical for tank construction, for example steel or high-grade steel. In particular if a seal of a corrosion-stable material is used, it is possible also to use materials which are not corrosion-stable with respect to the liquid comprised in the tank for the wall of the tank.

Suitable corrosion-stable materials from which the seal may be produced are, for example, graphite or aluminum.

If the device for storing hot, corrosively active liquids is a tank, it is usually closed by a tank cover. Insulating elements are then likewise provided on the tank cover. The insulation of the tank cover also avoids in the region of the tank cover—especially when the tank is completely filled—the tank cover coming into contact with the hot, corrosively active liquid. Moreover, it also avoids heat being given off to the surroundings via the tank cover.

Apart from a tank, the storage space enclosed by a wall may also be a cavity in the ground. In this case it is possible on the one hand for the cavity to be a natural cavity, while alternatively it is also possible for example to produce a cavity artificially. The advantage of a cavity in the ground is that greater heights of the reservoir can be realized, since it can be subjected to a higher hydrostatic pressure than conventional tanks because the forces occurring on the wall as a result of the hydrostatic pressure are absorbed by the ground. A great height for the space is appropriate in particular whenever the corrosively active liquid comprised in the space is a heat reservoir intended to be operated as a thermocline reservoir. In a heat reservoir operated as a thermocline reservoir there is cold liquid at the bottom and hot liquid at the top. A great height increases the time it takes for the temperature to be equalized by heat conduction. In this way it is possible to realize very large heat reservoirs, for example for solar power plants, which can be used, for example, as daily, weekly and in principle also monthly or even yearly reservoirs. This is helpful in particular because natural energy sources such as wind and the sun fluctuate.

A further advantage of a cavity in the ground is that a heat reservoir for a solar power plant can also be operated under pressure and at a maximum temperature well above 440° C., since a system pressure of more than 1 bar can be applied even in the case of large reservoirs. A further advantage is that the hot, corrosively active liquid can be kept in a cavity in the ground with the exclusion of air, allowing the risk of fire to be greatly reduced.

The inner insulation of the cavity in the ground avoids the hot, corrosively acting liquid coming into contact with the ground and releasing substances from the ground or reacting with them and entraining the substances released or the reaction products.

The substances or reaction products released from the ground may, for example, cause damage by increased corrosion or by leaving deposits on further components of a plant in which the device for storing hot, corrosively active liquids is used. A cavity in the ground may, for example, be artificially produced completely above ground, for example by artificially building up a hill in which such a cavity is formed. Furthermore, a cavity in the ground may be partially below ground, it being possible to use both cavities that have already been caused naturally and artificial cavities. It is also possible for the cavity to be created completely underground. In this case, natural cavities are used in particular. According to the invention, an inner insulation is introduced into the cavity in the ground. As already described above, this inner insulation serves in particular for avoiding liquid that is stored in the cavity releasing substances from the ground or reacting with substances from the ground.

Alumina, silicon carbide, silica, aluminum foam, glass foam or mixtures thereof are suitable, for example, as the material of the inner insulation, both for use in a tank and for use in a cavity. It is also possible to provide multiple layers, it being possible for the layers to be produced from different materials.

In particular if the device for storing the hot, corrosively acting liquid is a tank, in particular a tank with a metal wall, for example a steel wall, it is possible in spite of the inner insulation for the tank wall to be at a temperature which can, for example if touched, cause injuries. In this case it is preferred if the tank wall is additionally surrounded by an outer insulation. Suitable for the outer insulation are, for example, mineral fiber mats or standard glass foam panels. With an additional covering of a metal sheet, for example zinc sheet, ingress of moisture into the insulation can be avoided.

The device according to the invention for receiving hot, corrosively acting liquids is suitable in particular for receiving a heat storage medium in a solar power plant, for example a parabolic-trough solar power plant. Heat storage media which can be used are, for example, molten salts or sulfur-comprising heat storage media. Suitable in particular as a sulfur-comprising heat storage medium is elementary sulfur. To adapt the vapor pressure and the melting pressure, it is advantageous to add at least one anion-comprising additive to the sulfur.

Suitable in particular as anion-comprising additives are those which, at the operating temperature, do not oxidize the sulfur into corresponding oxidation products, for example sulfur oxides, sulfur halides or sulfur oxide halides. Furthermore, it is advantageous if the anion-comprising additives dissolve well in the sulfur.

Preferred anion-comprising additives are ionic compounds of a metal of the periodic table of elements with monoatomic or polyatomic singly or multiply negatively charged anions.

Metals of ionic compounds are, for example, alkali metals, preferably sodium, potassium; alkaline earth metals, preferably magnesium, calcium, barium; metals of the 13th group of the periodic table of elements, preferably aluminum; transition metals, preferably manganese, iron, cobalt, nickel, copper, zinc.

Examples of such anions are: halides and polyhalides, for example fluoride, chloride, bromide, iodide, triiodide; chalcogenides and polychalcogenides, for example oxide, hydroxide, sulfide, hydrogen sulfide, disulfide, trisulfide, tetrasulfide, pentasulfide, hexasulfide, selenide, telluride; pnicogens, for example amide, imide, nitride, phosphide, arsenide, pseudohalides, for example cyanide, cyanate, thiocyanate; complex anions, for example phosphate, hydrogen phosphate, dihydrogen phosphate, sulfate, hydrogen sulfate, sulfite, hydrogen sulfite, thiosulfate, hexacyanoferrates, tetrachloroaluminate, tetrachloroferrate.

Examples of anion-comprising additives are: aluminum(III)chloride, iron(III)chloride, iron(II) sulfide, sodium bromide, potassium bromide, sodium iodide, potassium iodide, potassium thiocyanate, sodium thiocyanate, disodium sulfide (Na2S), disodium tetrasulfide (Na2S4), disodium pentasulfide (Na2S5), dipotassium pentasulfide (K2S5), dipotassium hexasulfide (K2S6), calcium tetrasulfide (CaS4), barium trisulfide (BaS3), dipotassium selenide (K2Se), tripotassium phosphide (K3P), potassium hexacyanoferrate (II), potassium hexacyanoferrate (Ill), copper (I) thiocyanate, potassium triiodide, cesium triiodide, sodium hydroxide, potassium hydroxide, cesium hydroxide, sodium oxide, potassium oxide, cesium oxide, potassium cyanide, potassium cyanate, sodium tetraaluminate, manganese(I1)sulfide, cobalt(II)sulfide, nickel(II)sulfide, copper(11) sulfide, zinc sulfide, trisodium phosphate, disodium hydrogen phosphate, sodium dihydrogen phosphate, disodium sulfate, sodium hydrogen sulfate, disodium sulfite, sodium hydrogen sulfite, sodium thiosulfate, tripotassium phosphate, dipotassium hydrogen phosphate, potassium dihydrogen phosphate, dipotassium sulfate, potassium hydrogen sulfate, dipotassium sulfite, potassium hydrogen sulfite, potassium thiosulfate.

For the purposes of this application, anion-comprising additives are, furthermore, mixtures of two or more compounds of a metal of the periodic table of elements with monoatomic or polyatomic formally singly or multiply negatively charged anions, preferably anions based on non-metal atoms. According to the current state of knowledge, the quantitative ratio of the individual components is not critical here.

The mixture according to the invention preferably comprises elementary sulfur in the range from 50 to 99.999% by weight, preferably in the range from 80 to 99.99% by weight, particularly preferably 90 to 99.9% by weight, in each case with respect to the total mass of the mixture according to the invention.

The mixture according to the invention preferably comprises anion-comprising additives in the range from 0.001 to 50% by weight, preferably in the range from 0.01 to 20% by weight, particularly preferably 0.1 to 10% by weight, in each case with reference to the total mass of the mixture according to the invention.

The mixture according to the invention may comprise further additives, for example additives which reduce the melting point of the mixture. The proportion of further additives generally lies in the range from 0.01 to 50% by weight, in each case with respect to the total mass of the mixture.

Furthermore, mixtures of alkali polysulfides of the general formula

(M¹ₓM²₍₁₋ₓ₎)₂S_{y}

may also be used, where M¹, M²=Li, Na, K, Rb, Cs and M¹ is not the same as M2 and 0.05≦x≦0.95 and 2.0≦y≦6.0.

In a preferred embodiment of the invention, M¹=K and M2=Na.

In a further preferred embodiment of the invention, 0.20≦x≦0.95. In a particularly preferred embodiment of the invention, 0.50≦x≦0.90.

In a further preferred embodiment of the invention, 3.0≦y≦6.0. In a particularly preferred embodiment of the invention, y=4.0, 5.0 or 6.0.

In a particularly preferred embodiment of the invention, M^{l}=K, M²=Na, 0.20≦x≦0.95 and 3.0≦y≦6.0.

In a most particularly preferred embodiment of the invention, M′=K, M2=Na, 0.50≦x≦0.90 and y=4.0, 5.0 or 6.0.

Likewise suitable are mixtures of alkali polysulfides and alkali thiocyanates according to the general formula

((M¹×M²₍₁₋ₓ₎)₂S_{y})ₘ(M³_{z}M⁴_{(1-z)}SCN)₍₁₋ₘ₎

where M¹, M², M³, M⁴=Li, Na, K, Rb, Cs and M¹ is not the same as M², M³ is not the same as M⁴ and 0.05≦x≦1, 0.05≦z≦1, 2.0≦y≦6.0 and m is the quantitative proportion of substance with 0.05≦m≦0.95.

In a preferred embodiment of the invention, M¹ and M³=K and M² and M⁴=Na.

In a further preferred embodiment of the invention, 0.20≦x≦1. In a particularly preferred embodiment of the invention, 0.50≦x≦1.

In a further preferred embodiment of the invention, 3.0≦y≦1. In a particularly preferred embodiment of the invention, y=4.0, 5.0 or 6.0.

In a further preferred embodiment of the invention, 0.20≦z≦1. In a particularly preferred embodiment of the invention, 0.50≦z≦1.

In a further preferred embodiment of the invention, 0.20≦m≦0.80. In a particularly preferred embodiment of the invention, 0.33≦m≦0.80.

In a particularly preferred embodiment of the invention, M¹ and M³=K, M² and M⁴=Na, 0.20≦x≦1, 0.20≦z≦0.95, 3.0 5. y≦6.0 and 0.20≦n≦0.95.

In a most particularly preferred embodiment of the invention, M¹ and M³=K and M² and M⁴=Na, 0.50≦x≦1, 0.50≦z≦0.95, y=4.0, 5.0 or 6.0 and 0.33≦m≦0.80.

In a further particularly preferred embodiment of the invention, M¹ and M³=K, x=1, z=1, y=4.0, 5.0 or 6.0 and 0.33≦m≦0.80.

In a further particularly preferred embodiment of the invention, M¹ and M³=K, x=1, z=1, y=4 and m=0.5.

In a further particularly preferred embodiment of the invention, M¹ and M³=K, x=1, z=1, y=5 and m=0.5.

In a further particularly preferred embodiment of the invention, M¹ and M³=K, x=1, z=1, y=6 and m=05.

Apart from the use for receiving a heat storage medium in a solar power plant, the device according to the invention may, however, also be used as tanks or reactors that are exposed to high temperature corrosion and are always operated with the same medium. The device according to the invention is unsuitable for operation with different media, since the space enclosed by the wall can only be cleaned with difficulty. Unavoidable chinks and gaps retain remains of media which cannot be removed, or only with great difficulty.

Embodiments of the invention are explained in more detail in the description which follows and are represented in the figures, in which:

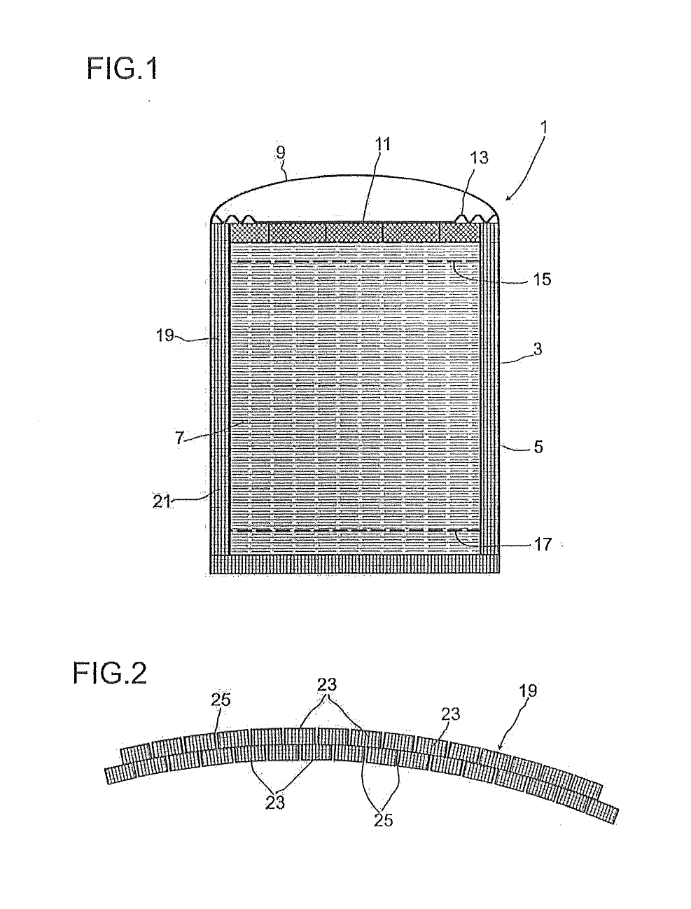

FIG. 1 shows a device formed as a thermocline reservoir for receiving hot, corrosively acting liquids,

FIG. 2 shows a detail of a self-supporting inner insulation,

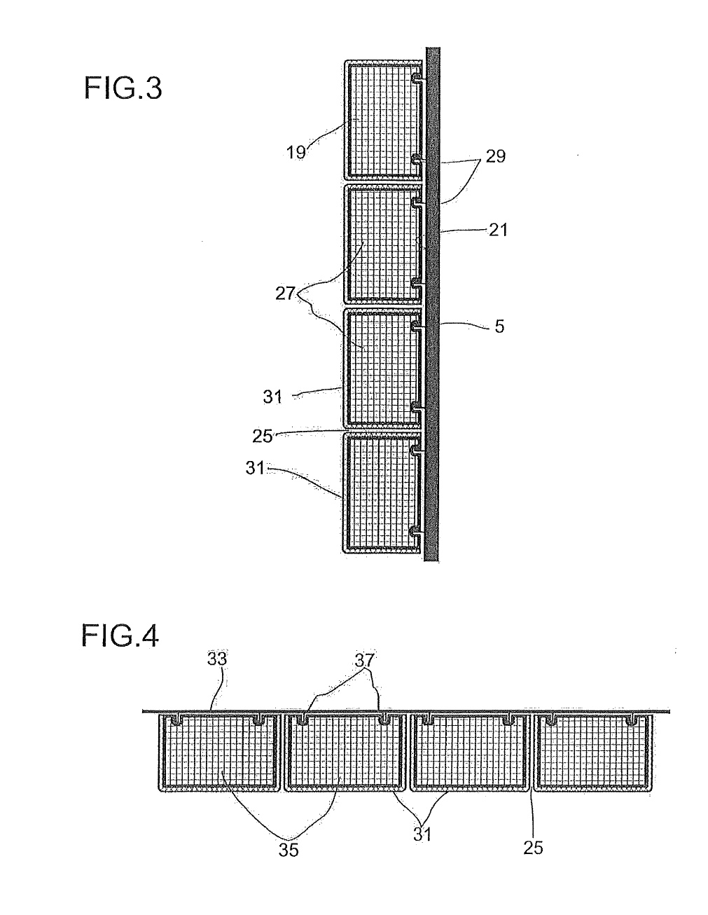

FIG. 3 shows an example of the structure of an inner insulation with insulating panels,

FIG. 4 shows a structure of a tank cover with insulating elements,

FIG. 5 shows a structure of a tank wall with self-supporting inner insulation,

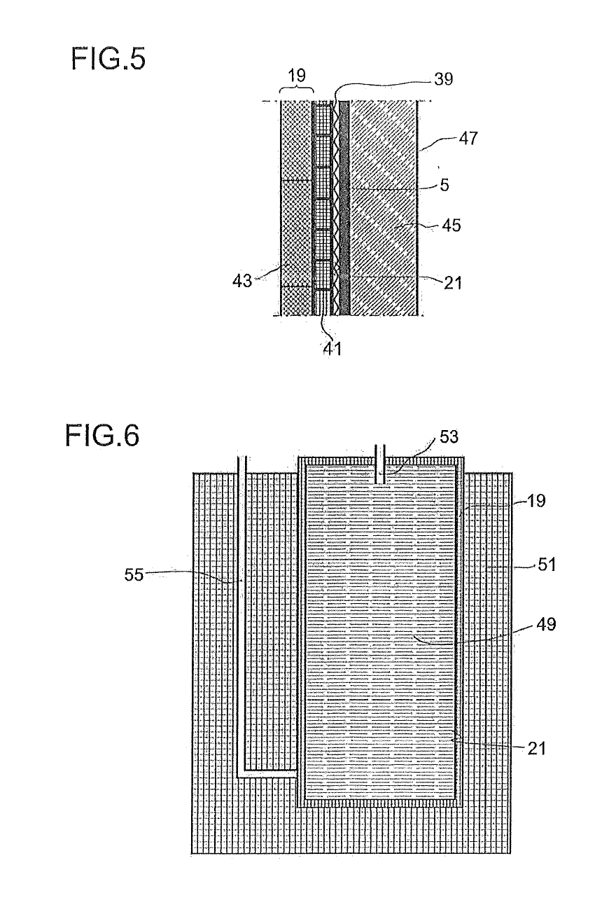

FIG. 6 shows a schematic representation of a device for receiving hot, corrosively acting liquids as a cavity in the ground,

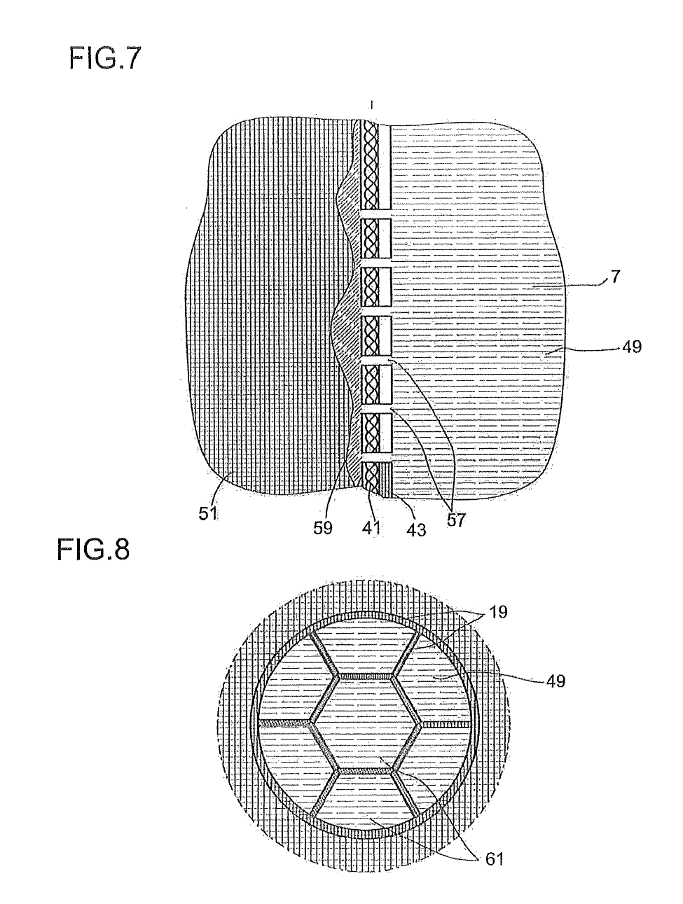

FIG. 7 shows the structure of the self-supporting inner insulation in a cavity in the ground,

FIG. 8 shows the device designed as a composite reservoir for receiving hot, corrosively acting liquids,

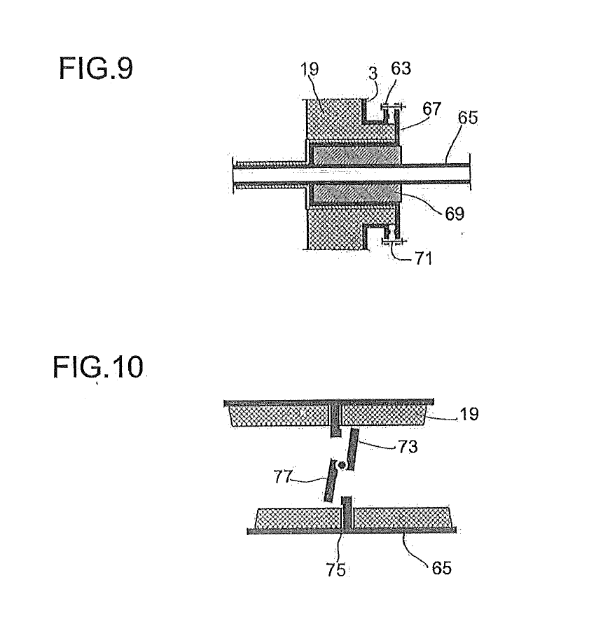

FIG. 9 shows a flange connection with inner insulation,

FIG. 10 shows a flap with inner insulation.

In FIG. 1, a device formed as a thermocline reservoir for receiving a hot, corrosively acting liquid is represented.

A thermocline reservoir 1, as represented in FIG. 1, may be used, for example, as a heat reservoir in a solar power plant.

The thermocline reservoir 1 comprises a tank 3, which is constructed for example from a metallic material, for example steel. For this purpose, a tank wall 5 is produced from the metallic material, the wall thickness of the tank wall 5 being chosen such that it is mechanically stable with respect to the pressures occurring in the tank. To be taken into consideration in particular here is the downwardly increasing hydrostatic pressure of a liquid 7 comprised in the tank. The tank 3 is closed by a tank cover 9. In addition, a further cover 11 may be provided, resting on the liquid 7 comprised in the tank 3 when the tank 3 is completely filled, so that no gas is comprised in the tank 3. To compensate for fluctuations in the liquid level, it is possible for compensating regions 13 to be provided on the further cover 11. These may, for example, take the form of a bellows. The compensating region 13 allows the further cover 11 to be positively connected to the tank wall 5, for example by a welding process. This makes a gastight connection possible. When there is an increase in the liquid level or a decrease in the liquid level, the further cover 11 is then raised or lowered, so that it always closes off the tank in such a way that no gas is comprised in the tank. Alternatively or in addition, it is also possible to compensate for changes in the volume of the storage material in response to a change in temperature by supplying or removing liquid, for example from a buffer tank.

If the tank 3 is used as a thermocline reservoir 1, there is a first manifold 15 in the upper region of the tank 3. By way of the first manifold 15, hot liquid can be uniformly fed into the tank. At the same time, to keep the level of the liquid in the tank constant, colder liquid is removed by way of a second manifold 17 at the bottom of the tank 3. Cold liquid is uniformly removed through the first manifold 15 and the second manifold 17, so that preferably no convective flow occurs, and consequently a very small vertical heat conduction arises in the tank. In this way it is possible to store liquid in the tank such that generally colder liquid of higher density is comprised in the lower region and warmer liquid of lower density is comprised in the upper region. In the ideal case, the liquid in the tank has two temperatures, that is a higher temperature in the upper region and a lower temperature in the lower region. Between the hot region and the cold region, a temperature boundary layer forms. Since heat conduction in the liquid cannot be prevented, in an actual case it is not possible however for there to be a sharp delineation between hot and cold liquid, but instead there forms a temperature transition from the hot liquid to the colder liquid. The longer the storage continues, the more and more indistinct the transition becomes, as a result of heat conduction.

In a solar power plant, the supply of hot liquid takes place by way of the first manifold 15 and the removal of colder liquid takes place by way of the second manifold 17, when the liquid used as the heat storage medium is heated up by solar energy. If the sun does not shine, but electricity is to continue being generated in the solar power plant, the heat stored in the heat storage medium is used for vaporizing water to drive the turbines driving the generators. For this purpose, the hot heat storage medium is removed from the tank 3 by way of the first manifold 15, gives off heat into a heat exchanger, in which the water used as an operating fluid is vaporized and superheated, and the cold heat storage medium is then returned by way of the second manifold 17 in the lower region of the tank. By removing the hot heat storage medium from the tank 3 and by removing cold heat storage medium during heating up, the temperature boundary layer in the tank 3 shifts in each case. During heating up of the heat storage medium, i.e. when hot heat storage medium is supplied by way of the first manifold 15 and colder liquid is removed by way of the second manifold 7, the temperature boundary layer shifts downward, whereas, when the heat stored in the liquid 7 is used, the temperature boundary layer is shifted upward, since the amount of hot heat storage medium in the tank 3 decreases and the amount of cold heat storage medium, the heat of which has already been used, increases.

Used, for example, as the liquid 7 which serves as the heat storage medium is a molten salt or a sulfur-comprising heat storage medium. Suitable in particular as the sulfur-comprising heat storage medium is elementary sulfur, which however may be contaminated or comprise further additives. Both molten salts and sulfur are highly corrosive at relatively high temperatures with respect to iron- or nickel-comprising materials. For example, molten nitrates cause the embrittlement of high-grade steels at temperatures over 550° C. Although the high-grade steels remain stable, they become sensitive to impact. Sulfur-comprising heat storage media, for example sulfur with 1% potassium sulfide, produce notable corrosion on typical iron/nickel high-grade steels at temperatures above 350° C., leading in a short time to penetrative destruction of the high-grade steels as the temperature increases from 500° C.

Chloride-comprising molten salts are also highly corrosive at high temperatures.

To prevent the corrosion, according to the invention an inner insulation 19 is included in the tank 3. The inner insulation 19 avoids the liquid 7 comprised in the tank 3 coming into contact with the wall 21, which encloses the space receiving the liquid 7. Moreover, on account of the insulation, the temperature at the wall 21 is much lower than the temperature of the liquid 7 in the tank 3.

An example of the structure of the inner insulation 19 is represented in FIG. 2. The inner insulation, as it is represented in FIG. 2, is self-supporting. For this purpose, substantially cuboidal elements or—to correspond to the rounding of the tank—optionally also slightly trapezoidal elements 23 or else elements 23 in the form of circular segments are arranged offset in two rows. Between every two cuboidal elements 23 of a row there is a gap 25. The gaps 25 serve to compensate for different thermal expansions of the materials of the inner insulation 19 and the tank wall 5. To build up the inner insulation as it is represented in FIG. 2, the cuboidal elements 23 are laid in rows of layers one above the other, it being preferred for cuboidal elements 23 that are lying one above the other likewise to be arranged offset in relation to one another. The offset arrangement has the effect of limiting the geometrical extent of the gaps 25. Furthermore, it is preferred that the gaps 25 are dimensioned such that no convective flow occurs. Although liquid 7 can flow into the gaps 25, a constant mass transfer in the gaps should be avoided once they are filled with the liquid 7. In particular in the case of poorly heat conducting liquids, as is the case for example with a molten sulfur, the liquid comprised in the gaps 25 then also has an insulating effect. The design in two offset rows, such as that represented in FIG. 2, avoids liquid getting through the inner insulation 19 to the wall 21.

In an alternative embodiment, it is also possible for the inner insulation to be built up from one row of cuboidal elements 23. In this case, the liquid passes through the gaps 25 to the wall 21. On account of the insulating effect of the insulation 19 and as a result of the gaps 25 being designed in such a way that no convective flow occurs, the temperature of the liquid that has flowed through the gaps 25 is also reduced, so that the temperature of the liquid coming into contact with the wall 21 is lower than the temperature of the liquid 7 in the tank 3. The thickness of the insulation 19 is in this case chosen such that the temperature of the liquid 25 passing through the gaps is such that the temperature lies below the temperature at which the liquid has a highly corrosive effect on the material of the wall 21.

In FIG. 3, an example of the structure of an inner insulation of insulating panels is represented. As a difference from the embodiment of an inner insulation 19 represented in FIG. 2, the inner insulation 19 that is represented in FIG. 3 is not self-supporting. The inner insulation 19 comprises individual insulating panels 27, which are mounted on the wall 21. The wall thickness of the wall 21, which forms the tank wall 5, is chosen such that the wall 21 is stable with respect to forces acting on it, for example as a result of the hydrodynamic pressure of the liquid comprised in the tank.

To provide the insulation, the insulating panels 27 are, for example, secured to the wall 21 by suitable wall hooks 29. The advantage of using wall hooks 29 is that the individual insulating panels 27 of the inner insulation 19 can be mounted in a simple way and, if need be, can also be taken down again. Apart from securing with wall hooks 29, however, it is also possible to secure the insulating panels 27 to the wall 21 in any other desired way known to a person skilled in the art. For example, it is also possible to adhesively attach the insulating panels to the wall 21. This has the disadvantage, however, that it is no longer easily possible to take them down.

To compensate for stresses occurring, the insulating panels 27 are also mounted such that a gap 25 is respectively produced between two insulating panels 27. The dimensions of the gaps 25 should also be chosen in the embodiment represented in FIG. 3 in such a way that no convective flow occurs in the gap 25. As a result, during filling, the gap 25 is filled by liquid running in, but this then remains in the gap 25 and thus likewise serves to provide insulation. Since the insulating panels 26 do not generally lie flush against the wall 21, liquid also flows behind the insulating panels 27. However, the insulation with the insulating panels 27 has the effect that the liquid that comes into contact with the wall 21 has already cooled down to such an extent that it no longer has a corrosive effect on the wall 21.

To protect the insulating panels 27 from corrosion, it is possible to provide them additionally with a corrosion-resistant coating 31. Suitable here as the corrosion-resistant coating is any desired coating known to a person skilled in the art. Suitable coatings are, for example, coatings with enamel or an A1203 coating.

A coating 31 of the insulating panels 27 is particularly appropriate whenever a material which is not stable with respect to the liquid 7 comprised in the tank is used as the material for the insulating panels 27.

A possible structure of a tank cover with insulating elements is represented in FIG. 4.

The structure represented in FIG. 4 for a tank cover corresponds substantially to the structure represented in FIG. 3 of a tank wall with insulating panels mounted on it.

To ensure an insulation also in the upward direction, insulating elements 35 are provided on the tank cover 33. In a way analogous to that represented in FIG. 3, the insulating elements 35 may, for example, be secured with the aid of hooks 37. However, securement by screw connections or adhesive bonding is also possible, for example. Depending on the material used for the insulating elements 35 and the liquid 7 to be stored in the tank, it is possible to coat the insulating elements 35 with a corrosion-resistant coating 31. If gaps 25 are formed between the individual insulating elements 35, it is also preferred on the tank cover 33 to be able to compensate for different thermal expansions of the insulating material of the insulating elements 35 and the material of the tank cover 33.

In FIG. 5, a structure of a tank wall with self-supporting inner insulation is represented.

The tank wall 5 is formed by a load-bearing steel shell. This is designed so as to be mechanically stable and able to absorb the forces acting, for example as a result of pressures occurring, without deforming. On the inside, the tank wall 5 is adjoined by a corrosion-resistant seal 39. The corrosion-resistant seal 39 is, for example, a high-grade steel inliner. This may, for example, take the form of a corrugated metal sheet. The use of the corrosion-resistant seal 39 makes it possible to use as material for the tank wall 5 a steel which is not corrosion-stable with respect to the liquid comprised in the tank. The corrosion-resistant seal 39 avoids the liquid being able to come into contact with the material of the tank wall 5.

The corrosion-resistant seal 39 is adjoined on the inside by a first insulating layer 41. The first insulating layer 41 is preferably self-supporting and built up from cuboidal elements which are laid one on top of the other in layers. It is advantageous if gaps are formed between the individual cuboidal elements of the first insulating layer 41, as also represented for example in FIG. 2 The first insulating layer 41 is, for example, of a highly heat-insulating material. Good insulation is achieved as a result. The first insulating layer 41 is adjoined by a second insulating layer 43. The second insulating layer 43 is, for example, produced from an abrasion-resistant material, so that it also serves in particular for the purpose that the inner insulation 19 is not damaged by movement of the liquid in the tank. The second insulating layer 43 is also preferably self-supporting and laid in layers of cuboidal elements. Here, too, it is advantageous if gaps are formed between the individual elements of the second insulating layer 43, to be able to compensate for different thermal expansions of the materials of the first insulating layer 41, the second insulating layer 43 and the tank wall 5.

Liquid can flow through the gaps 25 between the individual elements of the first insulating layer 41 and the second insulating layer 43 in the direction of the wall 21. The liquid then collects at the corrosion-resistant seal 39. The fact that on each of both sides of the insulation 19 there is liquid at the same pressure, as a result of pressure equalization, avoids the occurrence of a high internal pressure acting on the insulation 19 and not compensated from the outside. This largely avoids deformation of the inner insulation 19.

Since, in spite of the inner insulation 19, the temperature at the tank wall 5 may be so high that there is the risk of injuries, for example if the tank wall 5 is touched, it is also possible for the tank wall 5 to be adjoined on the outside by an outer insulation 45. The outer insulation 45 may, for example, be formed from conventional insulating materials, for example mineral fibers or glass fibers. To make the tank weatherproof, the outer insulation 45 is then covered, for example, with metal sheets 47. The metal sheets 47 that are used are, for example, commercially available zinc sheets, which are particularly weather-resistant.

In FIG. 6, a device for receiving hot, corrosively active liquids is schematically represented in the form of a cavity in the ground.

As a difference from the structure represented in FIGS. 1 to 5, it is alternatively also possible to design the device for receiving the hot, corrosively active liquid as a cavity 49 in the ground 51. This has the advantage that there is no need for a tank confinement in the form of a tank wall 5 which is stable with respect to high pressures. The forces acting on the wall 21 are absorbed by the ground 51. The device may, for example, likewise be a thermocline reservoir. If the device for receiving the liquid is a thermocline reservoir, a first inflow 53 is provided in the upper region, allowing the hot heat storage medium to be fed into the cavity 49 or removed from the cavity 49, and a second inflow 55 is provided, opening out into the lower region of the cavity 49 and allowing cold heat storage medium to be removed or fed in. The function otherwise corresponds to the thermocline reservoir represented in FIG. 1.

As a difference from a thermocline reservoir in the form of a tank, in the case of a cavity 49 in the ground 51 it is possible to realize much greater heights of the reservoir. As a result, the diameter can be reduced for the same amount of heat storage medium, so that the temperature boundary layer is made smaller. This makes it possible to operate the thermocline reservoir over a longer period of time without complete temperature equalization taking place by heat conduction. This is possible in particular because the ground can absorb very much greater compressive forces than a conventional tank wall 5 of steel.

To avoid substances being released from the ground 51 by the liquid that is comprised in the cavity 49 and serves as the heat storage medium, and possibly reacting with the liquid to form undesired products, the cavity 49 is lined with an inner insulation 19 in the same way as the tank represented in FIG. 1. The structure of the inner insulation 19 is in this case substantially the same as that represented in FIGS. 3 and 5.

A further possibility for a structure of an inner insulation 19 in a cavity in the ground 51 is represented in FIG. 7. Also in the embodiment represented in FIG. 7, the inner insulation 19 comprises a first insulating layer 41 and a second insulating layer 43. The second insulating layer 43 is preferably self-supporting and comes into contact with the liquid 7 comprised in the cavity 49. For this purpose, the second insulation 43 is, for example, laid in layers of cuboidal elements. The first insulating layer 41 serves as additional insulation and is, for example, produced from a material which can bear pressure, so that the second insulating layer 43 is pressed against the first insulating layer 41 on account of the pressure acting on it of the liquid comprised in the cavity 49, and the forces acting as a result are borne by the first insulating layer 41.

The first insulating layer 41 may, for example, be formed from glass foam or insulating bricks.

It is preferred if passages 57 are formed in the inner insulation 19. The passages 57 serve in this case as relief outlets, through which liquid can flow behind the inner insulation 19.

The passages 57 are in this case designed such that a convective flow is avoided, so that liquid flows once through the passages 57 and, for example, flows into voids 59 that are located behind the inner insulation 19. If the liquid comprised in the cavity 49 is sulfur, it cools down in the voids 59 and solidifies, whereby the inner insulation 19 is supported by pressure from behind. To ensure continuous pressure equalization, it is advantageous if the temperature at the passages 57 always remains so high that the sulfur does not solidify but continues to be in a molten state. For this purpose it is possible, for example, to provide temperature sensors with which the temperature is measured. If the temperature decreases too much, it is then possible, for example, to melt the solidified sulfur again by the use of suitable heating elements.

The same also applies correspondingly to the use of molten salts, for example, which should likewise be kept in the liquid state in the region of the passages 57 and, if the temperature decreases too much, be able to be heated, for example, in order to liquefy them again.

To be able to realize very large thermocline reservoirs with a correspondingly large cross-sectional area, it is possible to provide composite reservoirs with masonry inner walls. Such a reservoir is represented by way of example in FIG. 8. The use of a composite reservoir makes it possible to keep the span of a tank roof within limits that are feasible in static design. To produce the composite reservoir, the cavity 49 is divided into discrete individual reservoirs 61 by inner insulations 19. The same liquid, for example a molten sulfur, is contained in each of the individual reservoirs. The respective individual reservoirs, which are separated from each other by the inner insulation 19, are advantageously hydrostatically connected by lead-throughs. This makes it possible to keep the liquid level in the discrete individual reservoirs 61 uniform.

In FIG. 9, a flange connection with inner insulation is represented.

To be able to feed liquid into the tank or remove it, it is necessary to connect lines to the tank. The connection to lines usually takes place by suitable flanges. Such a flange connection is represented by way of example in FIG. 9. For this purpose, a flange 63 is formed on the tank 3. A line 65 is connected to a second flange 67. The second flange 67 is in this case designed to be partially concentric about the line 65, insulating material 69 being included between the flange 67 and the line 65. At the same time, between the first flange 63 on the tank 3 and the second flange 67 there is the inner insulation 19. This design also achieves uniform insulation in the region of the flange The connection of the first flange 62 and the second flange 67 takes place by conventional connecting measures, for example by means of screws 71. In addition, a sealing element is usually positioned between the first flange 63 and the second flange 67.

A flap in a line which is provided with an inner insulation is represented in FIG. 10.

To provide corrosion protection in particular for lines through which hot, corrosively acting liquid flows, it is also possible likewise to provide the lines with an inner insulation 19. To control the through-flow, it is possible, for example, to use fittings. Such fittings are, for example, flaps 73. In the region of the flap 73, the inner insulation 19 is interrupted, a stop 75 being located in the region of the interruption. To close the line 65, the flap 73 may be positioned such that it strikes against the stop 75. By pivoting the flap 73, the line 65 can be opened. Use of the inner insulation 19 prevents the hot material that flows through the line 65 from coming into direct contact with the material of the line 65. To protect the stop 75 and the flap 73, they are preferably provided with a high-temperature and corrosion-resistant coating 77.

The inner insulation 19, not only in lines and fittings but also in tanks, makes it possible to design an installation which is operated with hot, corrosively acting liquids. Such an installation is, for example, a solar power plant, for example a parabolic-trough solar power plant.

### EXAMPLES

### Example 1

A tank with inner insulation contains sulfur at a temperature of 390° C. The tank has an inner insulation 19 of refractory bricks. The tank wall is formed from steel. On the outside, the steel is enclosed by an outer insulation of mineral wool.

Table 1 shows the temperatures which respectively occur at the transitions from brick to steel, steel to mineral wool and mineral wool to the surroundings.

TABLE 1
Temperature profile in a device according to the invention with inner
insulation of refractory bricks

| | Thick- | Thermal | Apparent | Heat | Tem- |
|---|---|---|---|---|---|
| | ness | conductivity | density | capacity | perature |
| Layer | [cm] | [VV/mK] | [kg/m3] | [KJ/kgK] | [° C.] |
| Inner | | | | | 390 |
| temperature | | | | | |
| Refractory | 25 | 0.112 | 2100 | 1 | 236 |
| bricks | | | | | |
| Steel | 0.5 | 50 | 7850 | 0.47 | 236 |
| Mineral wool | 12 | 0.04 | 20 | 0.85 | 30 |

It can be seen from the temperature profile that the temperature decreases from the inside of the refractory bricks to the outside of the refractory bricks by 154° C. The temperature at which molten material possibly passing through the refractory bricks comes into contact with the tank wall of steel is consequently 236.41° C. This is a temperature at which most steels are corrosion-resistant to sulfur and additives comprised by the sulfur. Corrosion consequently does not occur.

### Example 2

A structure in which hot sulfur at a temperature of 390° C. comes into contact with the inner insulation is considered. The inner insulation is built up from a layer of refractory bricks and a glass foam layer, which adjoins the refractory bricks. Between the glass foam layer and the tank wall of steel there is a gap, into which sulfur has flowed.

The temperatures respectively on the outside of the individual layers are listed in Table 2.

TABLE 2
Temperature profile in a device according to the invention
with two insulating layers

| | Thick- | Thermal | Apparent | Heat | Tem- |
|---|---|---|---|---|---|
| | ness | conductivity | density | capacity | perature |
| Layer | [cm] | [W/m K] | [kg/m3] | [KJ/kgK] | [° C.] |
| Inner | | | | | 390 |
| temperature | | | | | |
| Refractory | 25 | 0.112 | 2100 | 1 | 245 |
| bricks | | | | | |
| Glass foam | 20 | 0.06 | 140 | 0.85 | 30.2 |
| Sulfur | 0.1 | 0.269 | 1960 | 0.71 | 30.0 |
| Steel | 0.5 | 50 | 7850 | 0.47 | 30.0 |

The additional layer of glass foam, preferably of borosilicate glass or quartz glass, which has been introduced between the tank wall of steel and the refractory bricks, has the effect of reducing the temperature at the wall of steel to such an extent that it is only 30° C. At this temperature, corrosion on the steel shell is no longer likely. The sulfur that is between the glass foam and the tank wall of steel is solid.

Moreover, no outer insulation is necessary, since the temperature of the tank wall of steel is already so low that it does not present any risk if touched.

List of designations

| | |
|---|---|
| 1 | thermocline reservoir |
| 3 | tank |
| 5 | tank wall |
| 7 | liquid |
| 9 | tank cover |
| 11 | further cover |
| 13 | compensating region |
| 15 | first manifold |
| 17 | second manifold |
| 19 | inner insulation |
| 21 | wall |
| 23 | cuboidal element |
| 25 | gap |
| 27 | insulating panel |
| 29 | wall hook |
| 31 | corrosion-resistant coating |
| 33 | tank cover |
| 35 | insulating element |
| 37 | hook |
| 39 | corrosion-resistant seal |
| 41 | first insulating layer |
| 43 | second insulating layer |
| 45 | outer insulation |
| 47 | metal sheet |
| 49 | cavity |
| 51 | ground |
| 53 | first inflow |
| 55 | second inflow |
| 57 | passage |
| 59 | void |
| 61 | individual reservoir |
| 63 | flange |
| 65 | line |
| 67 | second flange |
| 69 | insulating material |
| 71 | screw |
| 73 | flap |
| 75 | stop |
| 77 | high-temperature and |
| | corrosion-resistant coating |

1-14. (canceled)

15. A device for receiving hot, corrosively acting liquids, comprising:
a space enclosed by a wall for receiving a liquid, wherein the space has an inner insulation.

16. The device according to claim 15, wherein the inner insulation has passages through which the liquid stored in the space can flow.

17. The device according to claim 15, wherein the inner insulation is self-supporting.

18. The device according to claim 15, wherein the inner insulation is built up from individual elements, which are secured to the wall of the enclosed space.

19. The device according to claim 15, wherein the inner insulation is built up from substantially cuboidal elements.

20. The device according to claim 19, wherein the passages are gaps between the cuboidal elements.

21. The device according to claim 15, wherein the inner insulation is built up from a first insulating layer and a second insulating layer, adjoining the first insulating layer.

22. The device according to claim 15, wherein a seal of a corrosion-stable metal is included between the inner insulation and the wall.

23. The device according to claim 15, wherein the inner insulation comprises alumina, silicon carbide, silica, aluminum foam, glass foam or a mixture thereof.

24. The device according to claim 15, wherein the space enclosed by a wall for receiving the liquid is a tank.

25. The device according to claim 24, wherein the wall of the tank is produced from steel or high-grade steel.

26. The device according to claim 24, wherein the tank is closed by a tank cover and insulating elements are provided on the tank cover.

27. The device according to claim 15, wherein the enclosed space for receiving the liquid is a cavity in the ground.

28. The device according to claim 15, wherein the device is used for storing a heat storage medium comprising sulfur.
